(19) United States
(12) Patent Application Publication
(10) Pub. No.: US 2007/0067166 A1
(43) Pub. Date: Mar. 22, 2007

(54) Method and device of multi-resolution vector quantilization for audio encoding and decoding

(76) Inventors: Xingde Pan, Beijing (CN); Weimin Ren, Beijing (CN)

Correspondence Address: J C PATENTS, INC., 4 VENTURE, SUITE 250, IRVINE, CA, 92618, US

(21) Appl. No.: 10/572,769

(22) PCT Filed: Sep. 17, 2003
(86) PCT No.: PCT/CN03/00790

§ 371 Date: Jul. 21, 2006

(51) Int. Cl. G10L 19/12

(52) U.S. Cl. 704/222

(57) ABSTRACT

The present invention provides a method and device of multi-resolution vector quantization (VQ) for audio encoding and decoding used to analyze the audio signal in multi-resolution and quantize the vectors of them. Said method for encoding audio comprises the steps of: adaptively filtering a input audio signal so as to gain a time-frequency filter coefficient and output a filtered signal; dividing vectors of the filtered signal in a time-frequency plane so as to gain a vector combination; selecting the vector to be quantized; quantizing the selected vectors and calculating a quantization residual error; and transmitting a quantized coding task information as a side-information of an encoder to an audio decoder to quantize and encode the quantization residual error. The invention can adaptively filter the audio signal, and adjust the resolutions of time and frequency. The hereinafter result of multi-resolution time-frequency analysis can be utilized effectively through reorganizing the filter coefficient by selecting different organizing policies. VQ may improve encoding efficiency as well as control quantizing precision simply and optimize it.

### FIELD OF THE INVENTION

The present invention relates to the field of signal processing, and more particularly, to an encoding and decoding method and device which realizes analyzing the audio signals in multi-resolution and quantizing the vectors of them.

### BACKGROUND OF THE INVENTION

Generally, audio encoding method comprises the steps of psychological acoustic model calculating, time-frequency domain mapping, quantizing, encoding, etc., wherein time-frequency domain mapping refers to mapping the input audio signal from the time domain into the frequency domain or the time-frequency domain.

Time-frequency domain mapping is also called transforming and filtering, which is a basic operation of audio signal encoding, and can enhance encoding efficiency. Most information contained in the time domain signals can be transformed or collected into a subset of the frequency domain or time-frequency domain coefficients by such operation. One of the basic operations of the perceptual audio encoder is mapping the input audio signal from the time domain into the frequency domain or the time-frequency domain. The basic thought is: decomposing the signal into the components of each frequency band; once the input signal is expressed in the frequency domain, the psychological acoustic model could be used to eliminate; grouping the components on each frequency band; at last rationally distributing the bit number to express the frequency parameter of each group. If the audio signal shows a strong quasi-periodicity, the process could greatly decrease the data bulk and increase encoding efficiency. At present, the commonly used time-frequency mapping methods include: Discrete Fourier Transform (DFT) method, Discrete Cosine Transform (DCT) method, Quadrature Mirror Filter (QMF) method, Pseudo Quadrature Mirror Filter (PQMF) method, Cosine Modulation Filter (CMF) method, Modified Discrete Cosine Transform (MDCT) method, Discrete Wavelet (Packet) Transform (DW(P)T) method, etc. However, the above methods should either adopt a transform/filter collocation to compress and express an input signal frame, or adopt the analysis filter bank of smaller time domain interval or transform compression to express signals with violent variation in order to eliminate the effect to decoding signals made by pre-echo. When an input signal frame comprises different components of transient characteristics, single transform collocation cannot meet the essential requirement of optimizing and compression for different signal sub-frame; simply using the analysis filter bank with of smaller time domain interval or transform to process the rapidly changed signal, the frequency resolution of the obtained coefficient is low, which makes the frequency resolution of the low frequency part much higher than the critical sub-band bandwidth of human ear, and greatly influences encoding efficiency.

In the process of audio encoding, when the time domain signals are mapped into the time-frequency domain signals, using vector quantization technique can increase encoding efficiency. At present, the audio encoding method which applies vector quantization technique in audio encoding is Transform-domain Weigthed Interleave Vector Quantization (TWINVQ) encoding method. In this method, when the signals are MDCT transformed, it constructs the vector to be quantized by cross selecting signal spectrum parameter, then the quality of encoding audio with low bit rate increase obviously by using vector quantization with high efficiency. However, because it cannot effectively control the quantized noise and due to human ear masking, TWINVQ encoding method is essentially an encoding method with perpetual loss, and requires to be further improved when seeking a higher subjective audio quality. At the same time, since interlacing coefficient is adopted by TWINVQ encoding method in organizing vectors, although it could ensure the statistic coherence between the vectors, not only the phenomenon that the signal energy is concentrated in the local time-frequency domain cannot be effectively used, but also further improvement of encoding efficiency is restricted. Furthermore, since MDCT transform is substantively a kind of filter bank with equal bandwidth, it cannot divide the signals according to the signal energy's convergence in the time-frequency plane, which limits the efficiency of TWINVQ encoding method.

Therefore, how to effectively use the time-frequency local convergence of the signals and the high efficiency of the vector quantization technique is a core problem of improving encoding efficiency. In particular, it relates to two aspects: at first, the time-frequency plane should be divided effectively so that the between-class distance of the signal components is as long as possible, but the within-class distance thereof is as short as possible, which is to solve the multi-resolution filter problem of the signals; secondly, it needs to rebuild, select and quantized the vector on the basis of an effectively divided time-frequency plane so as to maximize the encoding gain, which is to solve the multi-resolution vector quantization problem of the signals.

### SUMMARY OF THE INVENTION

The present invention provides a method and device of multi-resolution vector quantization for audio encoding and decoding, which can adjust the time-frequency resolution according to different types of input signals, and effectively use local convergence of the signals in the time-frequency domain to process the vector quantization in order to increase encoding efficiency.

A method of multi-resolution vector quantization for audio encoding of the present invention comprises: adaptively filtering an input audio signal so as to gain a time-frequency filter coefficient and outputting a filtered signal; dividing vectors of the filtered signal in a time-frequency plane so as to gain a vector combination; selecting vectors to be quantized; quantizing the selected vectors and calculating a residual error of quantization; and transmitting a quantized codebook information as a side-information of an encoder to an audio decoder to quantize and encode the residual error of quantization.

A method of multi-resolution vector quantization for audio decoding, of the present invention comprises the following steps of: demultiplexing a code stream to gain a side information of the multi-resolution vector quantization, an energy of a selected point and location information of vector quantization; inverse quantizing vectors to obtain a normalized vector according to the above information and calculating a normalization factor to rebuild a quantized vector in an original time-frequency plane; adding the rebuilt vector to a residual error of a corresponding time-frequency coefficient according to the location information; obtaining a rebuilt audio signal by inverse filtering in multi-resolution and mapping from frequency to time.

A device of multi-resolution vector quantization for audio encoding of the present invention comprises: a time-frequency mapper, a multi-resolution filter, a multi-resolution vector quantizer, a psychological acoustic calculation module and a quantization encoder;the time-frequency mapper for receiving an input audio signal to process mapping from time to frequency domain and output to the multi-resolution filter;the multi-resolution filter foradaptively filtering the signal, and outputting a filtered signal to the psychological acoustic calculation module and the multi-resolution vector quantizer;the multi-resolution vector quantizer for vector quantizing the filtered signal and calculating a residual error of quantization, transmitting a quantized signal as a side information to an audio decoder and outputting the residual error of quantization to the quantization encoder;the psychological acoustic calculation module for calculating a masking threshold of a psychological acoustic model according to the input audio signal, and outputting to the quantization encoder so as to control noise allowed in quantization ;the quantization encoder for quantizing and entropy coding the residual error output by the multi-resolution vector quantizer to gain an encoded code stream information under restriction of the allowed noise output by the psychological acoustic calculation module.

A device of multi-resolution vector quantization for audio decoding of the present invention comprises: a decoding and inverse—quantizing device, a multi-resolution inverse-vector quantizer, a multi-resolution inverse filter and a frequency-time mapper; the decoding and inverse-quantizing device for demultiplexing, entropy decoding and inverse-quantizing a code stream to obtain a side information and encoding data and outputting to the multi-resolution inverse-vector quantizer; the multi-resolution inverse-vector quantizer for quantizing a inverse-vector to rebuild a quantized vector, adding and outputting a rebuilt vector to a residual coefficient of a time-frequency plane to the multi-resolution inverse filter; the multi-resolution inverse filter for inverse filtering a sum signal got by adding the vector rebuilt to a residual error coefficient by the multi-resolution vector quantizer and outputting to the frequency-time mapper; the frequency-time mapper for mapping a signal from frequency to time to obtain a final rebuilt audio signal.

The audio encoding and decoding methods and devices basing on the Multi-resolution Vector Quantization (MRVQ) technique of the present invention can adaptively filter the audio signal, utilize the phenomenon that signal energy locally converges in the time-frequency area more effectively by filtering in multi-resolution, and adaptively adjust the resolutions of time and frequency according to the types of signals; the result of multi-resolution time-frequency analysis can be utilized effectively through reorganizing the filter coefficient by selecting different organization policies complying with signal's convergence feature; vector quantizing these areas may improve encoding efficiency as well as control quantizing precision simply and optimize it.

### BRIEF DESCRIPTION OF THE DRAWINGS

FIG. 1 is a flow chart of the method of multi-resolution vector quantization for audio encoding of the present invention;

FIG. 2 is a flow chart of multi-resolution filtering of the encoding method of the present invention;

FIG. 3 is a diagrammatic sketch of the signal resource encoding/decoding system basing on Cosine Modulation Filter;

FIG. 4 is a diagrammatic sketch of three convergence modes of the multi-resolution filtered energy;

FIG. 5 is a flow chart of the process of multi-resolution vector quantization;

FIG. 6 is a diagrammatic sketch of dividing vector according to the three modes;

FIG. 7 is a flow chart of an embodiment of multi-resolution vector quantization;

FIG. 8 is a diagrammatic sketch of the area energy/maximum.;

FIG. 9 is a flow chart of another embodiment of multi-resolution vector quantization;

FIG. 10 is a structural diagram of the audio encoder of multi-resolution vector quantization of the present invention;

FIG. 11 is a structural diagram of the multi-resolution filter in the audio encoder;

FIG. 12 is a structural diagram of the multi-resolution vector quantizer in the audio encoder;

FIG. 13 is a flow chart of the method of multi-resolution vector quantization for audio decoding of the present invention;

FIG. 14 is a flow chart of multi-resolution inverse filtering;

FIG. 15 is a structural diagram of the audio decoder of multi-resolution vector quantization of the present invention;

FIG. 16 is a structural diagram of the multi-resolution inverse vector quantizer in the audio decoder;

FIG. 17 is a structural diagram of the multi-resolution inverse filter in the audio decoder.

### DETAILED DESCRIPTION OF THE PREFERRED EMBODIMENTS

Now, the present invention will be described in details with reference to the accompanying drawings and the preferred embodiments.

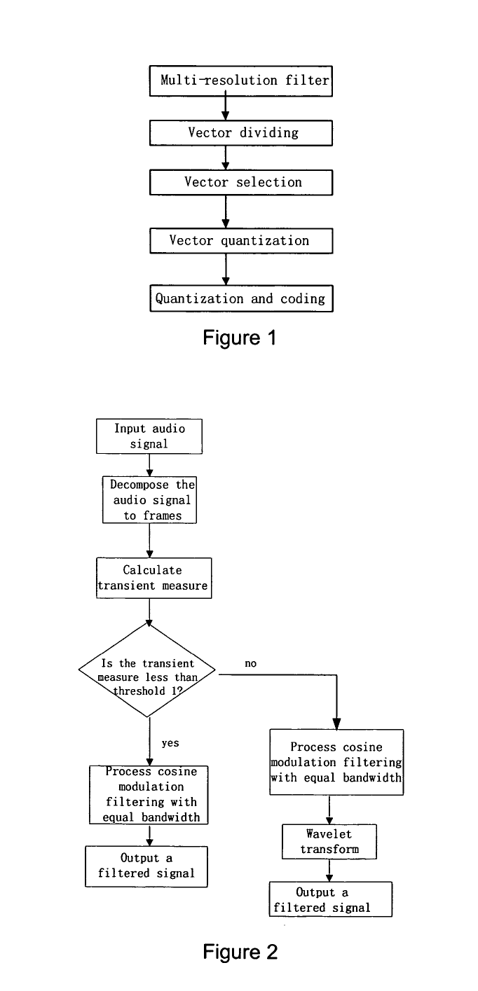

The flow chart shown in FIG. 1 provides the general technical solution of audio encoding method of the present invention: at first, filtering the input audio signal in multi-resolution, then rebuilding the filter coefficient, and dividing the vectors in the time-frequency plane; further selecting and determining the vector to be quantized; quantizing each vector when the vector is determined, and obtaining the corresponding vector quantized coding task and the residual error of quantization., the vector quantized coding task is transmitted to the decoder as the side information, and the quantization residual error is quantized and encoded.

A flow chart of multi-resolution filtering for the audio signal is shown in FIG. 2. Decompose the input audio signal into frames and calculate a transient measure of a signal frame. Discriminate whether the type of current signal frame is a graded signal or a fast-varying signal by comparing the value of the transient measure with the value of a threshold. Select the filtering structure of the signal frame according to different type of signal frame if it is the graded signal, proceed a cosine modulation filtering with equal bandwidth to gain the filter coefficient in the time-frequency plane and output the filtered signal. If it is the fast-varying signal, proceed the cosine modulation filtering with equal bandwidth to gain the filter coefficient in the time-frequency plane, analyze the filter coefficient in multi-resolution by wavelet transforming, adjust a time-frequency resolution of the filter coefficient, and finally output the filtered signal. For the fast-varying signal, it can further define a series of fast-varying signal types, i.e., subdivide the fast-varying signal by multiple thresholds analyze the fast-varying signal in different types in multi-resolution by different wavelet transforms, e.g. a wavelet base can be fixed or can be adaptive.

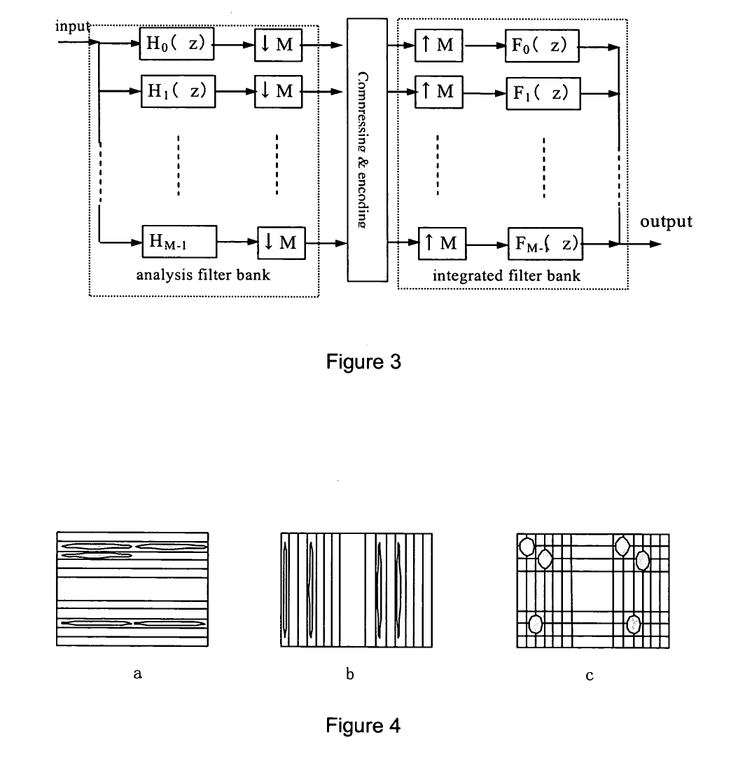

As above mentioned, filtering both the graded signal and the fast-varying signal is based on the technique of the cosine modulation filter bank, which comprises two filtering methods: the traditional Cosine Modulation Filter (CMF) method, and the Modified Discrete Cosine Transform (MDCT) method. The signal resource encoding/decoding system basing on Cosine Modulation Filter method is shown in FIG. 3. At the encoding end, the input signal is decomposed into M sub-bands by the analysis filter bank, and quantize and entropy encode the sub-band coefficient. At the decoding end, obtain the sub-band coefficient through entropy decoding and inverse-quantizing, and the sub-band coefficient is filtered by integrating the filter of the filter bank so as to renew the audio signal.

The impact response of the traditional Cosine Modulation Filter technique is:

$$\begin{matrix}{h}_{k} ( n ) = 2 {p}_{a} ( n ) cos ( \frac{π}{M} ( k + 0.5 ) ( n - \frac{D}{2} ) + {θ}_{k} ) \\ n = 0 , 1 , ⋯ , {N}_{h} - 1 & ( F \text{-} 1 ) \\ {f}_{k} ( n ) = 2 {p}_{s} ( n ) cos ( \frac{π}{M} ( k + 0.5 ) ( n - \frac{D}{2} ) - {θ}_{k} ) \\ n = 0 , 1 , ⋯ , {N}_{f} - 1 & ( F \text{-} 2 )\end{matrix}$$

wherein 0≦k<M−1, 0≦n<2KM−1, K is an integer bigger than 0,

$${θ}_{k} = {( - 1 )}^{k} \frac{π}{4} .$$

Here, set the length of impact response of an analysis window (analysis prototype filter) pₐ(n) of M sub-band cosine modulation filter bank is Nₐ, the length of impact response of an integrated window (or called integrated prototype filter) pₛ(n) of M sub-band cosine modulation filter bank is Nₛ, at this time, the delay D of the entire system can be limited within the scope of [M−1, Nₛ+Nₐ−M+1], and the delay of the system is D=2sM+d(0≦d≦2M−1).

When the analysis window equals to the integrated window, that is:
pₐ(n)=pₛ(n), and Nₐ=Nₛ (F-3)
the cosine modulation filter bank represented by formula (F-1) and (F-2) is an orthogonal filter bank, here, matrixes H and F ([H]_{n,k}=hₖ(n),[F]_{n,k}=fₖ(n)) are the orthogonal transform matrixes. To gain a linear phase filter bank, further define a symmetric window
pₐ(2KM−1−n)=pₐ(n) (F-4)

In order to ensure the complete reconfiguration of the orthogonal and bi-orthogonal systems, please refer to the document (P. P. Vaidynathan, “Multirate Systems and Filter Banks”, Prentice Hall, Englewood Cliffs, N.J.,1993) about the conditions that the window lo function should satisfy.

Another filter method is Modified Discrete Cosine Transform (MDCT) method, which is also called as TDAC (Time Domain Aliasing Cancellation) cosine modulation filter bank, and the impact response thereof is:

$$\begin{matrix}{h}_{k} ( n ) = {p}_{a} ( n ) \sqrt{\frac{2}{M}} cos ( \frac{π}{M} ( k + 0.5 ) ( n + \frac{M + 1}{2} ) ) & ( F \text{-} 5 ) \\ {f}_{k} ( n ) = {p}_{s} ( n ) \sqrt{\frac{2}{M}} cos ( \frac{π}{M} ( k + 0.5 ) ( n + \frac{M + 1}{2} ) ) & ( F \text{-} 6 )\end{matrix}$$

Wherein 0≦k<M−1, 0≦n<2KM−1, and K is an integer bigger than 0. Pₐ (n) and pₛ (n) respectively represent the analysis window (analysis prototype filter) and the integrated window (integrated prototype filter).

Likewise, when the analysis window equals to the integrated window, that is:
pₐ (n)=pₛ(n) (F-7)
the cosine modulation filter bank represented by formula (F-5) and (F-6) is an orthogonal filter bank, here, matrixes H and F ([H]_{n,k}=hₖ(n),[F]_{n,k}=fₖ(n)) are the orthogonal transform matrixes. To gain a linear phase filter bank, further define a symmetric window
pₐ(2KM−1−n)=pₐ(n) (F-8)

In order to ensure the complete reconfiguration, the analysis window and the integrated window should satisfy:

$${\sum }_{m = 0}^{2 K - 1 - 2 s} {p}_{a} ( mM + n ) {p}_{a} ( ( m + 2 s ) M + n ) = δ ( s ) \qquad ( F \text{-} 9 )$$

wherein s=0, . . . . , K−1, n=0, . . . M/2−1.

Relaxing the limitation condition of (F-7), i.e., canceling the limitation that the analysis window equals to the integrated window, so the cosine modulation filter bank is a bi-orthogonal filter bank.

It is proven by time domain analysis that the bi-orthogonal filter bank obtained according to (F-5) and (F-6) still satisfy the complete rebuilding performance, as long as

$$\begin{matrix}{\sum }_{m = 0}^{2 K - 1 - 2 s} {p}_{s} ( mM + n ) {p}_{a} ( ( m + 2 s ) M + n ) = δ ( s ) & ( F \text{-} 10 ) \\ {\sum }_{m = 0}^{2 K - 1 - 2 s} {( - 1 )}^{m} {p}_{s} ( mM + n ) {p}_{a} ( ( m + 2 s ) M + ( M - n - 1 ) ) = 0 & ( F \text{-} 11 )\end{matrix}$$

wherein s=0, . . . , K−1, n=0, . . . , M−1.

According to the above analysis, the analysis window and the integrated window of the cosine modulation filter bank (including MDCT) can adopt any window shape satisfying complete rebuilding condition of filter bank, such as SINE and KBD windows commonly used in audio encoding.

In addition, filtering of the cosine modulation filter bank can use Fast Fourier Transform to improve calculation efficiency. Please refer to “A New Algorithm for the Implementation of Filter Banks based on ‘Time Domain Aliasing Cancellation’ (P. Duhamel, Y. Mahieux and J. P. Petit,Proc.ICASSP, May 1991, Page 2209-2212).

Likewise, the wavelet transform technique is also a well-known technique in the field of signal processing. Please refer to the detailed discussion about the wavelet transform technique in “Sub-wave Transform Theory and Its Application In Signal Processing” (Chen Fengshi, China National Defense Industry Press, 1998).

The multi-resolution analyzed and filtered signal has the property of re-distribution and congregating the signal energy in time-frequency plane, as shown in FIG. 4. For the stable signal in time domain, for example, the orthogonal signal, in the time-frequency plane, its energy may congregate into one frequency band in the time direction, as shown by “a” of FIG. 4; for the time domain fast-varying signal, especially the fast-varying signal with obvious pre-echo phenomenon in audio encoding, for example, the castanet signal, its energy is mainly distributed in the frequency direction, i.e. a majority of the energy value congregates at few time points, as shown by “b” of FIG. 4; for the noise signal in time domain, its frequency spectrum is distributed in a wide scope, therefore there are several patterns of the energy convergence method which may distribute in the time direction, in the frequency direction, and by areas, as shown by “c” of FIG. 4.

In the multi-resolution distribution of time-frequency, the frequency resolution of the low frequency part is high, and the frequency resolution of the intermediate and high frequency part is low. Since the components inducing the pre-echo phenomenon are mainly in the intermediate and high frequency parts, pre-echo can be effectively restricted if the encoding quality of these components can be improved. An important purpose of multi-resolution vector quantization is optimizing the error introduced in quantization aiming at these important filter coefficients. Therefore, it is very important to use the encoding policy with high efficiency for these coefficients. The important filter coefficients can be re-organized and classified effectively according to the obtained time-frequency distribution of the filter coefficients of filtered signals in mutli-resolution. It can be known from the above analysis that the energy distributions of the filtered signals in multi-resolution shows a strong orderliness, therefore introducing the vector quantization can effectively use such property to organize the coefficients. Organize the area in the time-frequency plane to be one-dimensional vector matrix form by the vector organization adopting the special method. Then vector quantize all or part of the matrix elements of the vector matrix. Transmit the quantized information to the decoder as the side information of the encoder, and the residual error of quantization and the un-quantized coefficient together form a residual system to be quantized and encoded.

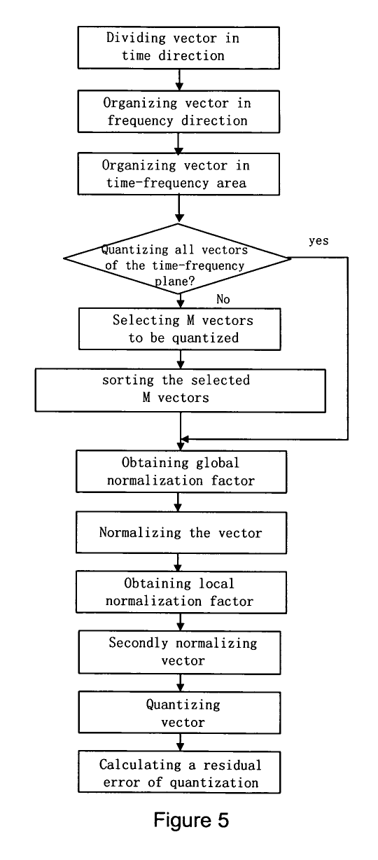

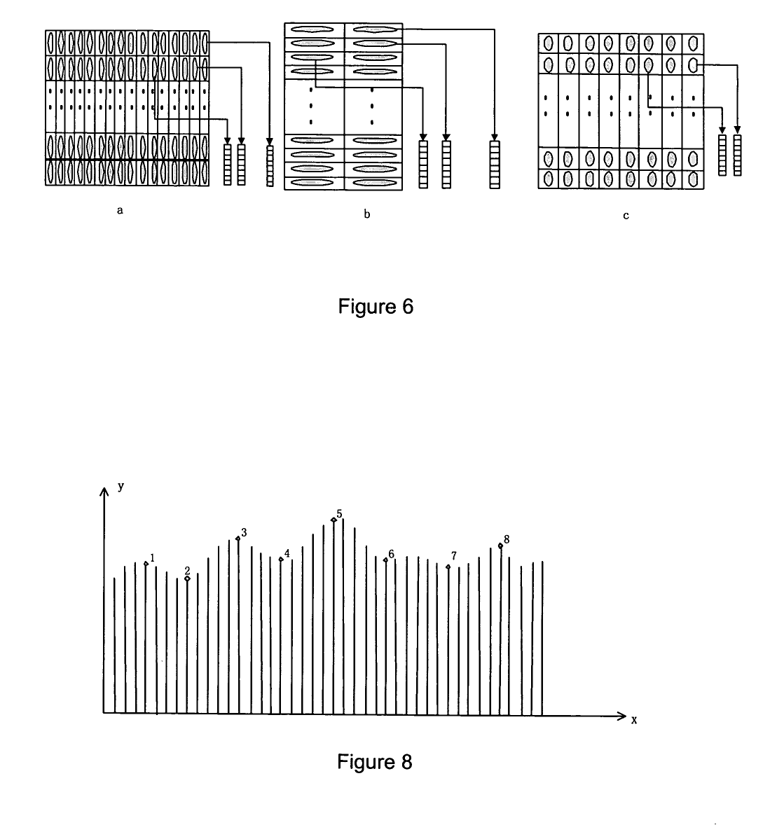

FIG. 5 describes the process of multi-resolution vector quantization after the audio signal is filtered in multi-resolution in details, and the process comprises three sub-processes of vector dividing, vector selection and vector quantization. In time-frequency plane the vectors can be divided according to the three modes of time direction, frequency direction and time-frequency area. To organize vector in time direction is adaptive to perform to the signal with strong tonality, to organize vector in frequency direction is adaptive to perform to the signal with the fast-varying characteristic in the time domain, while to organize vector in time-frequency area is appropriate for the complicated audio signal. Assume that the length of the frequency coefficient of the signal is N, after filtering in multi-resolution, the resolution in the time direction in the time-frequency plane is L, the resolution in the frequency direction is K, and K*L=N. At first, determine the size of the vector dimension D when dividing vector, whereby obtain the number of divided vectors is N/D. While dividing vector in the time direction, keep the resolution in the frequency direction unvaried, and divide the time; while dividing vector in the frequency direction, keep the resolution in the time direction L unvaried, and divide the frequency; while dividing vector in the time-frequency area, the number dividing in time and frequency direction can be arbitrary if only it satisfies the finally divided vector number N/D. FIG. 6 shows an embodiment of dividing vectors in time, frequency and time-frequency area. Assume that the length of the frequency coefficient is N=1024, after filtering in multi-resolution, the time-frequency plane is divided into the form of K*L=64*16, K=64 is the resolution in the frequency direction, and L=16 is the resolution in the time direction. Assume a vector dimension D=8, the time-frequency plane can be organized and vector can be extracted in different patterns, as shown of FIG. 6-a, FIG.6-b, and FIG. 6-c. In FIG.6-a, the vector is divided into 8*16 eight-dimension vectors in frequency direction, to be called as I type vector array. FIG. 6-b is the result of dividing the vector in the time direction, amounting for 64*2 eight-dimension vectors, to be called as II type vector array. FIG. 6-c is the result of dividing the vector in the time-frequency area, amounting for 16*8 eight-dimension vectors, to be called III type vector array. As such, 128 eight-dimension vectors can be gained by different dividing methods. The vector collection obtained by I type array is recorded as {v_{f}}, the vector collection obtained by II type array is recorded as {vₜ}, and the vector aggregate obtained by III type array is recorded as {v_{t-f}}.

After the process of vector dividing, determine which vectors are to be quantized, so as to select the vectors which can adopt two selection methods. The first method is selecting all the vectors in the entire time-frequency plane to be quantized, in which all the vectors refer to the vectors covering all the time-frequency grid points obtained according to a certain dividing, e.g. the vectors can be all the vectors obtained by I type vector array, or all the vectors obtained by II type vector array, or all the vectors obtained by III type vector array, only all the vectors in one of these arrays are necessary to be selected. Which vector aggregate should be selected is determined by the quantization gain, which is the ratio of the energy before quantization to the energy of the quantization error. Select the vectors in the vector array with large gain from the above vector array.

The second method is selecting the most important vector to be quantized. The most vectors can be the vector in the frequency direction, or the vector in the time direction or the vector in the time-frequency area. In the case where only part of the vectors is selected to be quantized, besides the quantization index is included in the side information, the serial number of these vectors is also needed to be included. The detailed vector selection methods are to be described in the followings.

Proceed to vector quantization after the vectors to be quantized are determined. Either selecting all the vectors to be quantized or selecting the important vectors to be quantized, the basic unit is quantizing the single vector. For the single D-dimension vector, considering a compromise of the dynamic scope and the size of the codebook, the vectors should be normalized before quantization to gain a normalization factor, which is the value reflecting the dynamic energy scope of different vectors and is varied. Quantizing the vectors after they are normalized includes quantization of codebook index and quantization of normalization factor. In consideration of the limitation of the coding rate and the encoding gain, the bit number occupied by quantizing quantization factor under satisfying the precision condition is as little as may be. In the present invention, the methods of curve and surface fitting, multi-resolution decomposition and prediction and the others are used to calculate an envelope of multi-resolution time-frequency coefficient to obtain the normalization factor.

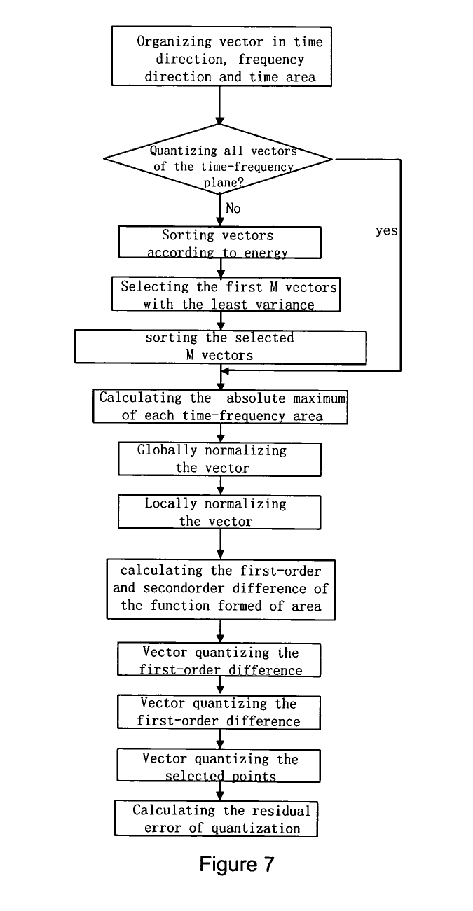

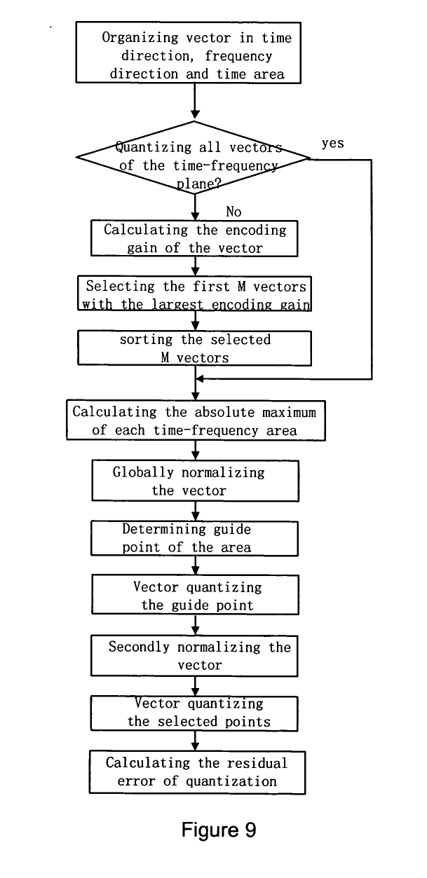

FIG. 7 and FIG. 9 respectively present the flow charts of two detailed embodiments of multi-resolution vector quantization. In the embodiment shown in FIG. 7, select the vectors according to the energy and the variance of components of the vector, describe the envelope of multi-resolution time-frequency coefficient by using Taylor Formula so as to obtain the normalization factor, and then quantize it for realizing the multi-resolution vector quantization. In the embodiment shown in FIG. 9, select the vectors according to the encoding gain, calculate an envelope of the multi-resolution time-frequency coefficient by using Spline Curve Fitting to obtain the normalization factor, and then quantize it for realizing the multi-resolution vector quantization. The two embodiments are described as below:

In FIG. 7, organize the vector in frequency direction, time direction and time-frequency area respectively. If the frequency coefficient N=1024, the multi-resolution filter in time-frequency produces the grid of 64*16. When the vector dimension is 8, a vector in 8*16 matrix form can be obtained by frequency dividing, a vector in 64*2 matrix form can be obtained by time dividing, and a vector in 16*8 matrix form can be obtained by time-frequency area.

If not quantize all the vectors, it needs to select the vector by importance. In said embodiment, the basis of selecting the vector is the energy of vector and the variance of each component of the vector. When calculating the variance, elements of the vector should be taken the absolute value to remove the effect of the symbols of numerical value. Set the aggregate V={v_{f}}U{vₜ}U{v_{t-f}}, the detailed process of selecting the vector is as the following: at first, calculate the energy of each vector in the aggregate V Evᵢ=|vᵢ|² , and at the same time calculate dEvi of each vector, wherein dEvᵢ represents the variance of each component of No. i vector. Sorting the elements in the aggregate V by energy from the biggest to the smallest; re-sorting the above sorted elements by variance from the smallest to the biggest. Determine the number Mo f vectors to be selected according to the ratio of the total energy of the signal to the total energy of the currently selected vector, and the typical value can take an integer from 3-50. Then select the first M vectors to be quantized; if the vectors in the same area are included in I type vector array, II type vector array and III type vector array at the same time, and then select according to the ordering of the variance. Select the M vectors to be quantized via the above steps.

After the M vectors are selected, complete the process of quantization search for each order difference by using Taylor Approximation Formula and different distortion measure rule respectively. For more efficient quantization, the vectors need to be normalized twice. When normalizing at the first time, adopt the global absolute maximum. When normalizing at the second time, estimate the signal envelope by the limited multipoint, and then normalize the vectors at the corresponding positions for the second time by the estimated value. The dynamic scope of the vector variation is controlled effectively after being normalized two times. The estimate method of the signal envelope is realized by Taylor Formula, which will be described in the following. Vector quantization is proceeded to the following steps: at first determine the parameters in Taylor Approximation Formula so as to use Taylor Formula to represent the approximate value of energy of any vectors in the entire time-frequency plane, and work out the maximum energy or absolute maximum thereof; then proceed to first normalization of the selected vectors; afterwards, calculate the approximate value of energy of the vector to be quantized by Taylor Formula to proceed to the second normalization; at last, quantize the normalized vectors based on the least distortion, and calculate the residual error of quantization. The above steps are herein described in details. In the time-frequency plane, the coefficient of each time-frequency grid corresponds to a certain energy value. Defining the coefficient energy of the time-frequency grid is the square or the absolute value of the coefficient; defining the vector energy is the sum of the coefficient energy of all the time-frequency girds forming the vector or the absolute maximum of these coefficient values; defining the energy of the time-frequency plane area is the sum of the coefficient energy of all the time-frequency girds forming the area or the absolute maximum of these coefficient values. In order to obtain the vector energy, it needs to calculate the energy sum or the absolute maximum of coefficients of all the time-frequency grids contained in the vector. Therefore, the dividing methods of FIG. 6-a, FIG. 6-b and FIG. 6-c can be used for the entire time-frequency plane, and number the divided areas as (1, 2, . . . N). If divide in frequency direction, each area corresponds to the vector in one frequency direction, calculate the energy or the absolute maximum of each area, and form a Unary Function Y=f(X), wherein X represents the serial number of the area, which values an integer in [1, N], and Y represents the energy or the absolute maximum corresponding to area X; and the point (Xᵢ, Yᵢ) , i values an integer in [1, N], which is also called a guide point. According to Taylor Formula:

$$f ( {x}_{0} + Δ ) = f ( {x}_{0} ) + {f}^{( 1 )} ( {x}_{0} ) Δ + \frac{1}{2 !} {f}^{( 2 )} ( {x}_{0} ) {Δ}^{2} + \frac{1}{3 !} {f}^{( 3 )} ( ξ ) {Δ}^{3} \qquad ( 1 )$$

The M values of the Unary Function Y=f(X) form a discrete sequence {y₁, y₂, y₃, y₄, . . . , y_{M}}, and the first-order, second-order and third-order differences can be gained by regression method, i.e., DY, D²Y and D³Y can be gained from Y.

What is shown in FIG. 8 is a diagrammatic sketch of the function Y=f(X) approximately represented by Taylor Formula, wherein the round points indicate the areas to be quantized and encoded selected from all the N areas, and N indicates the number of vectors gained by dividing the entire time-frequency plane. The detailed process of gaining a normalization factor is as following: define a Global_Gain according to the total energy of the signal and quantize and code it by a logarithm model. Then normalize the selected vectors by the Global_Gain; and calculate the local normalization factor Local_Gain of a current vector according to Taylor Formula (1) and normalize the current vector once again. Hence the general normalization factor—Gain of the current vector is provided by the product of the above two normalization factors:
Gain=Global_Gain*Local_Gain (2)
Wherein, Local_Gain does not need quantization at the encoder end. At the decoder end, Local_Gain can be obtained by the same process according to Taylor Formula (1). Multiply Global_Gain with the rebuilt normalized vector to gain the rebuilt value of the current vector. Therefore, the side information to be encoded at the encoder end is the function value, and the first-order and second-order differences of the selected round points in FIG. 8. The present invention uses the vector quantization to encode them. The process of vector quantization is described as following: the function value f(x) of the pre-selected M areas forms M-dimensional vector Y. The first-order and the second-order differences corresponding to the vector are already known, which are denoted by dy and d²y respectively, and the three vectors are quantized respectively. At the encoder end, the codebooks corresponding to the three vectors have been obtained by Codebook Training Algorithm, and the process of quantization is the process of searching the most matched vectors. Vector Y corresponds to the zero-order approximate expression of Taylor Formula, and adopts Euclidean distance for the distortion measure in codebook searching. Quantization of the first-order difference dy corresponds to the first-order approximation of Taylor Formula:
f(x₀+Δ)=f(x₀)+f⁽¹⁾(x₀)Δ (3)
Therefore, that quantizing the first-order difference firstly searches a few code words with the least distortion in the corresponding codebook according to Euclidean distance, then calculates a quantization distortion in each area of a small neighborhood at the current vector x₀ by using formula (3), and lastly sums the distortion to be the distortion measure, that is:

$$D = {\sum }_{k = - M}^{+ M} {( f ( x + {Δ}_{k} ) - \hat{f} ( x + {Δ}_{k} ) )}^{2} \qquad ( 4 )$$

Wherein f(x+Δₖ) represents the true value before quantization, \hat{f}(x+Δₖ) represents the approximate value gained by Taylor Formula, and M represents the scope of the neighborhood. The quantization of the second-order difference can use the same process. With the above processes, finally three quantized code word indexes can be gained to be transmitted to the decoder as the side information. And the residual error of quantization should be quantized and coded.

It is very easy to expand the above methods to the situation of two dimensional surfaces.

FIG. 9 is another embodiment of the process of multi-resolution vector quantization. At first, organize the vector in the frequency direction, time direction and time-frequency area respectively. If not quantize all the vectors, then calculate the encoding gain of each vector, select the first M vectors with the biggest encoding gain to proceed to vector quantization. The method to determine M value: sorting the vectors by energy from the largest to the smallest, and the number of vectors of which the percentage of the total energy is over one empirical threshold (for example 50%-90%) is M. For more efficient quantization, the vectors should be normalized twice. The global absolute maximum is adopted for the first time, and the Spline Curve Fitting Formula is adopted for calculating the normalization value of the vectors at second time. The dynamic scope of vector variation is effectively controlled after normalizing at twice.

Identical to the embodiment shown in FIG. 7, at first, re-divide the entire time-frequency plane and sort the results as (1, 2, . . . , N), calculate the energy or the absolute maximum of each area to form the a Unary Function Y=f(X), wherein X represents the serial number of the area, which values an integer in [1, N], and Y represents the energy or the absolute maximum corresponding to area X. According to B Spline Curve Fitting Formula:

The B spline function of the constant (power of 0) in No. i sub-interval is

$${N}_{i , 0} ( x ) = \{ \begin{matrix}1 , & {x}_{i} ⩽ x ⩽ {x}_{i + 1} \\ 0 , & other\end{matrix} \qquad ( 5 )$$

The B spline function of the power of m in the interval [xᵢ, xᵢ₊ₘ₊₁] is defined as:

$${N}_{i , m} ( x ) = \frac{( x - {x}_{i} )}{( {x}_{i + m} - {x}_{i} )} {N}_{i , m} ( x ) + \frac{( {x}_{I + m + 1} - x )}{( {x}_{I + m + 1} - {x}_{I + 1} )} {N}_{I + 1 , m - 1} ( x ) \qquad ( 6 )$$

Therefore, by using the B spline base function as the base, any spline can be represented as:

$$f ( x ) = {\sum }_{i = - m}^{k - 1} {a}_{i} {N}_{i , m} ( x ) \qquad ( 7 )$$

In this case, the function value of the spline of the given x point can be calculated according to formula (5), (6) and (7). The points for interpolation are also called guide points.

In the same way, FIG. 8 can be the diagrammatic sketch of the function Y=f(X) obtained by spline curve fitting, wherein the round points indicate the areas to be encoded, which are selected from all the N areas, and N indicates the number of vectors gained by dividing the entire time-frequency plane. The detailed process of vector quantization is as following: at the encoder end, for the vectors to be quantized, define a Global_Gain according to the total energy of the signal and quantize and encode it by a logarithm model. Then normalize the selected vectors by the Global_Gain; and calculate the local normalization factor Local_Gain of a current vector according to the fitting formula (7) and normalize the current vector once again. Hence the general normalization factor—Gain of the current vector is provided by the product of the above two normalization factors:
Gain=Global_Gain*Local_Gain (8)
Wherein, Local_Gain does not need quantization at the encoder end. Likewise, at the decoder end, Local_Gain can be obtained by the same process according to the fitting formula (7). Multiply the total gain with the rebuilt normalized vector to obtain the rebuilt value of the current vector. Therefore, the side information to be encoded at the encoder end is the function value of the selected round points shown in FIG. 8 while adopting the Spline Curve Fitting method. The present invention uses the vector quantization to encode them.

The process of vector quantization is described as the following: pre-select the function value f(x) of M areas to form a M-dimensional vector Y. Vector Y can be further decomposed into several component vectors to control the size of the vectors and improve the precision of the vector quantization, and these vectors are called vectors of the selected points. Then quantize vector Y respectively. At the encoder end, the corresponding vector codebooks can be obtained by Codebook Training Algorithm. The process of quantization is the process of searching the most matched vectors, and the code word indexes gained by searching are transmitted to the decoder as the side information. And the residual error of quantization should carry on the next quantization and encoding.

It is very easy to expand the above methods to the situation of two dimensional surfaces.

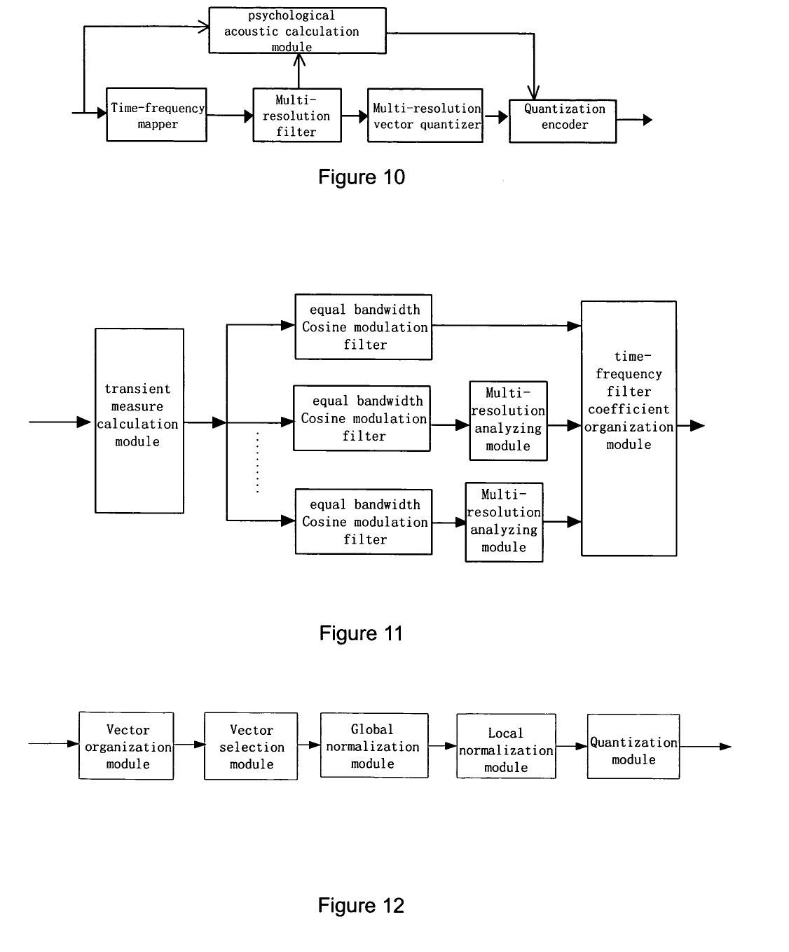

As shown in FIG. 10, the audio encoder comprises a time-frequency mapper, a multi-resolution filter, a multi-resolution vector quantizer, a psychological acoustic calculation module and a quantization encoder. The input audio signals to be encoded are divided into two paths, one path enters into the multi-resolution filter through the time-frequency mapper to carry out analysis in multi-resolution, and the analytical results act as an input of the vector quantization and for adjusting the calculation of the psychological acoustic calculation module; Another path enters into the psychological acoustic calculation module to estimate a psychological acoustic masking threshold of the current signal so as to control the unrelated apperceived information of the quantization encoder; the multi-resolution vector quantizer divides the coefficients in the time-frequency plane into vectors and proceed vector quantization according to the output of the multi-resolution filter, and quantize and entropy encode the residual error of quantization by the quantization encoder.

FIG. 11 is a structural diagram of the multi-resolution filter in the audio encoder shown in FIG. 10. The multi-resolution filter comprises a transient measure calculation module, multiple equal bandwidth cosine modulation filters , multiple multi-resolution analyzing modules and time-frequency filter coefficient organization modules; wherein the number of the multi-resolution analyzing modules is one less than the number of the equal bandwidth cosine modulation filters. The working principle is as the following: the input audio signals are divided into the graded signals and the fast-varying signals through the analysis of the transient measure calculation module. The fast-varying signals can be further subdivided into type I fast-varying signals and type II fast-varying signals. And the graded signals are input to the equal bandwidth cosine modulation filters to gain the required time-frequency filter coefficient; and all kinds of the fast-varying signals are filtered through the equal bandwidth cosine modulation filters firstly, and then enter into the multi-resolution analyzing modules to proceed wavelet transform for the filter coefficient, adjust the time-frequency resolution of the coefficient, and finally output the filtered signals by the time-frequency filter coefficient organization modules.

As shown in FIG. 12, the structure of the multi-resolution vector quantizer comprises a vector organization module, a vector selection module, a global normalization module, a local normalization module and a quantization module. The time-frequency plane coefficients output by the multi-resolution filter are organized into the vector form through the vector organization module according to different dividing policies. And then select the vectors to be quantized in the vector selection module according to the factors such as the size of the energy etc to output to the global normalization module. In said global normalization module, perform the first global normalization to all the vectors by the global normalization factor, and then calculate the local normalization factor of each factor in the local normalized module and perform the local normalization at second time so as to output to the quantization module. In the quantization module, quantize vectors which are normalized at twice and calculate the residual error of quantization as the output of the multi-resolution vector quantizer.

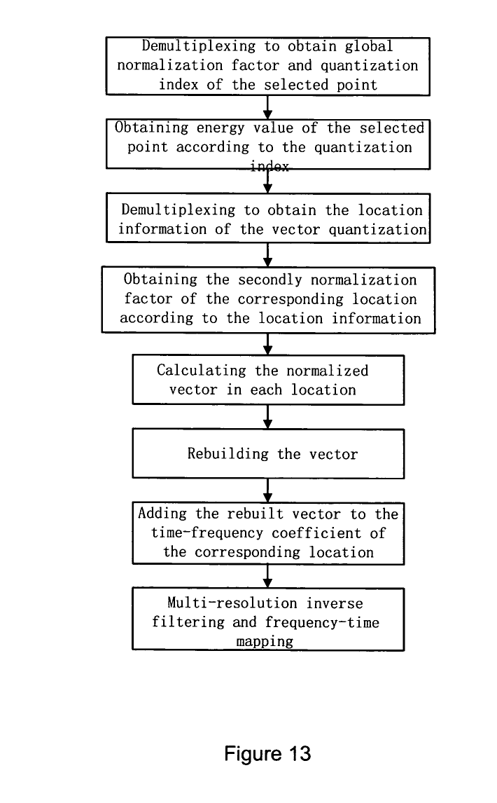

As shown in FIG. 13, the present invention provides the method of multi-resolution vector quantization for audio decoding. At first, demultiplex, entropy decode and inverse quantize the received code stream to gain the quantized global normalization factor and the quantization index of the selected points. Calculate the energy and the values of each order difference of each selected point from the codebook according to the index, obtain the location information of the vector quantization in the time-frequency plane from the code stream and obtain the second normalization factor in the corresponding position in accordance with the Taylor Formula or the Spline Curve Fitting Formula. And then obtain the normalized vector according to vector quantization index, and multiply it with the two normalization factors to rebuild the quantized vector in the time-frequency plane. Add the rebuilt vector to the coefficient of the corresponding position of the time-frequency plane which is decoded and inverse quantized, perform the multi-resolution inverse filtering and mapping from frequency to time, to complete decoding to gain the rebuilt audio signal.

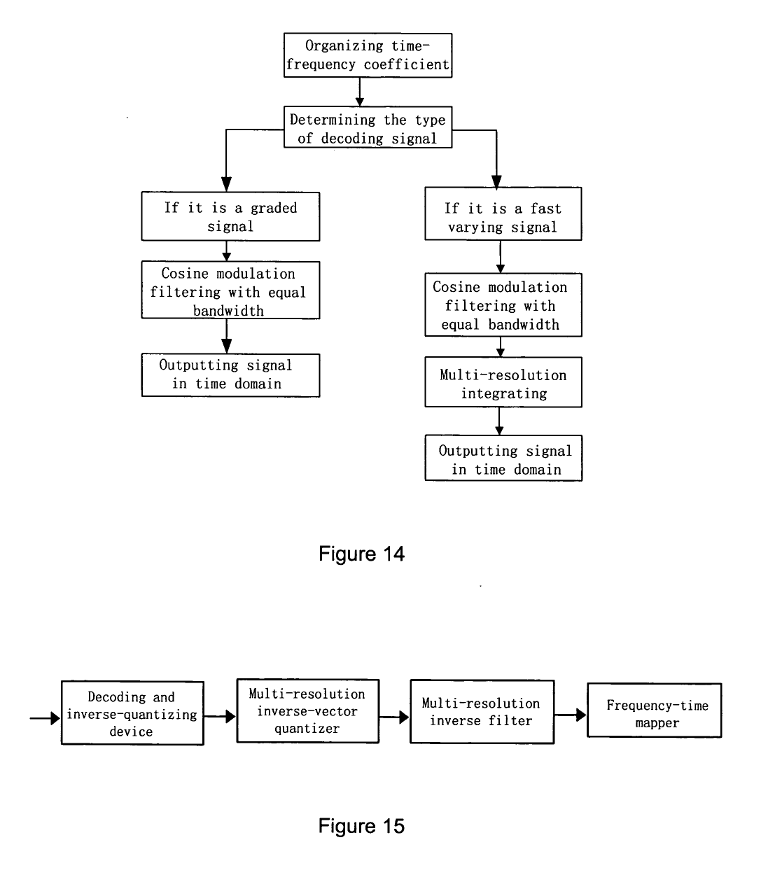

FIG. 14 introduces the process of multi-resolution inverse filtering in the decoding method firstly, organize the time-frequency for the time-frequency coefficient of the rebuilt vector, and perform the filtering according to types of signals obtained from decoding as the following: if it is the graded signal, proceed a cosine modulation filtering with equal bandwidth to gain an output of pulse code modulation (PCM) in a time domain; if it is the fast-varying signal, integrate in multi-resolution and proceed the cosine modulation filtering with equal bandwidth to gain the PCM output in the time domain. The fast-varying signal can be further subdivided into various types, and the method of integrating the multi-resolution differs for different types of fast-varying signals.

As shown in FIG. 15, the corresponding audio decoder particularly includes: a decoding and inverse-quantizing device, a multi-resolution inverse-vector quantizer, a multi-resolution inverse filter and a frequency-time mapper. The decoding and inverse-quantizing device demultiplexes the received code stream, as well as entropy decodes and inverse-quantizes to obtain the side information of multi-resolution vector quantization and outputs to the multi-resolution inverse-vector quantizer. The multi-resolution inverse-vector quantizer rebuilds the vector to be quantized according to the inverse-quantized result and the side information, and renews the value of the time-frequency plane; the multi-resolution inverse filter performs inverse filtering to the vector rebuilt by the multi-resolution inverse vector quantizer, and accomplishes mapping from frequency to time by the frequency-time mapper to gain the final rebuilt audio signal.

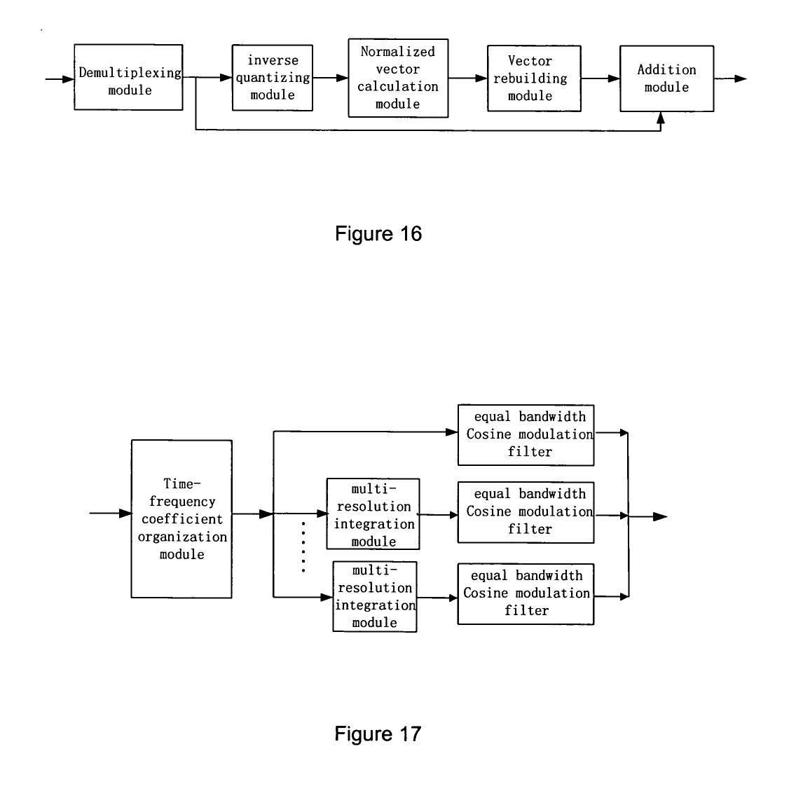

As shown in FIG. 16, the structure of the above multi-resolution inverse-vector quantizer comprises: a demultiplexing module, an inverse-quantizing module, a normalized vector calculation module, a vector rebuilding module and an addition module. At first, the demultiplexing module demultiplexes the received code stream to obtain the normalization factor and the quantization index of the selected point. Then in the inverse-quantizing module, obtain an energy envelope according to the quantization index and obtain the location information of the vector quantization according to the demultiplexed result, according to the normalization factor and the quantization index inverse-quantize them to obtain the vectors of a guide point and a selected point, calculate the second normalization factor, and output to the normalized vector calculation module. In the normalized vector calculation module, secondly inverse normalize the vector of the selected point to obtain the normalized vector, and output to the vector rebuilding module. And inverse normalize the normalized vector again according to the energy envelope, to obtain the rebuilt vector. In the addition module, add the rebuilt vector to the residual error of inverse quantization of the corresponding time-frequency plane to obtain an inverse-quantized time-frequency coefficient as an input of the multi-resolution inverse-filter.

As shown in FIG. 17, the structure of the multi-resolution inverse filter comprises: a time-frequency coefficient organization module, multiple multi-resolution integration modules and multiple equal bandwidth cosine modulation filters, wherein the number of the multi-resolution integration modules is one less than the number of the equal bandwidth cosine modulation filters. The rebuilt vectors are divided into the graded signal and the fast-varying signal through the time-frequency coefficient organization module, and the fast-varying signal can be further sub-divided into various types, such as I, II . . . K. For the graded signal, input to the equal bandwidth cosine modulation filters to gain PCM output in the time domain. For different types of the fast-varying signals, output to the multi-resolution integration module to be integrated and then output to the equal bandwidth cosine modulation filters for filtering to obtain PCM output in the time domain.

It will be understood that the above embodiments are used only to explain but not to limit the present invention. In despite of the detailed description of the present invention with referring to above preferred embodiments, it should be understood that various modifications, changes or equivalents can be made by those skilled in the art without departing from the spirit and scope of the present invention.

1. A method of multi-resolution vector quantization for audio encoding, characterized in that it comprises the steps of: adaptively filtering an input audio signal so as to gain a time-frequency filter coefficient and outputting a filtered signal; dividing vectors of the filtered signal in a time-frequency plane so as to gain a vector combination; selecting vectors to be quantized; quantizing the selected vectors and calculating a residual error of quantization; and transmitting a quantized codebook information as a side-information of an encoder to an audio decoder to quantize and encode the residual error of quantization.

2. The method of multi-resolution vector quantization for audio encoding of claim 1, wherein the procedure of said adaptively filtering an audio signal further comprises: decomposing the input audio signal into frames and calculating a transient measure of a signal frame; discriminating whether a type of a current signal frame is a graded signal or a fast-varying signal by comparing a value of the transient measure with a value of a threshold; if it is the graded signal, then proceeding a cosine modulation filtering with equal bandwidth to gain a filter coefficient in a time-frequency plane and output the filtered signal; if it is a fast-varying signal, then proceeding a cosine modulation filtering with equal bandwidth to gain a filter coefficient in a time-frequency plane, analyzing the filter coefficient in multi-resolution by a wavelet transform, adjusting a time-frequency resolution of the filter coefficient, and finally outputting the filtered signal.

3. The method of multi-resolution vector quantization for audio encoding of claim 2, wherein the cosine modulation filtering adopts a traditional cosine modulation filtering or a modified discrete cosine transform filtering.

4. The method of multi-resolution vector quantization for audio encoding of claim 3, wherein the cosine modulation filtering further comprises a Fast Fourier Transform.

5. The method of multi-resolution vector quantization for audio encoding of claim 2, wherein if it is the fast-varying signal, the procedure further comprises: subdividing the fast-varying signal into the fast-varying signal of various types and processing filtering and multi-resolution analysis respectively for different types of the fast-varying signal.

6. The method of multi-resolution vector quantization for audio encoding of claim 5, wherein a wavelet base of a wavelet transform during said processing multi-resolution analysis is fixed or adaptive for different types of the fast-varying signal.

7. The method of multi-resolution vector quantization for audio encoding of claim 1, wherein dividing vectors of the filtered signal in a time-frequency plane includes three methods: dividing in a time direction, in a frequency direction and in a time-frequency area;
said dividing in a time direction further includes keeping a resolution in the frequency direction unvaried and dividing time so as to make the number of divided vectors to be N/D and gain a I type vector array, wherein N means a length of a frequency coefficient of the audio signal, and D means dimensions of a vector;
said dividing in frequency direction further includes keeping a resolution in the time direction unvaried and dividing a frequency to make the number of divided vectors to be N/D and gain a II type vector array, wherein N means a length of a frequency coefficient of the audio signal, and D means dimensions of a vector;
said dividing in time-frequency area further includes dividing time and a frequency in the time-frequency plane to make the number of divided vectors to be N/D and gain a III type vector array, wherein N means a length of a frequency coefficient of the audio signal, and D means dimensions of a vector;

8. The method of multi-resolution vector quantization for audio encoding of claim 1, wherein the procedure of said selecting vectors to be quantized further includes: discriminating whether it is necessary to quantize all the vectors in the time-frequency plane, if yes, respectively calculating quantization gains of a I type vector array, a II type vector array and a III type vector array and selecting vectors in the vector array with a largest value of the quantization gain as the vectors to be quantized; else selecting M vectors to be quantized and encoding serial numbers of selected vectors.

9. The method of multi-resolution vector quantization for audio encoding of claim 8, wherein the procedure of said selecting M vectors to be quantized further includes: forming a vector aggregate from the vectors in the I type vector array, the II type vector array and the III type vector array; calculating an energy of each vector in said vector aggregate, i.e. square of the coefficient, as well as calculating a variance of each component of each vector sorting the vectors in the vector aggregate by the energy from the biggest to the smallest; re-sorting the above sorted vectors by the variance from the smallest to the biggest; determining the number M of vectors to be selected according to the ratio of a total energy of the signal to the total energy of the currently selected vectors, and selecting first M vectors to be the vectors to be quantized; if the vectors in a same area are included in the I type vector array, the II type vector array and the III type vector array at the same time making selection according to the ordering of the variance.

10. The method of multi-resolution vector quantization for audio encoding of claim 8, wherein the procedure of said selecting M vectors to be quantized further includes: forming a vector aggregate from the vectors of the I type vector array, the II type vector array and the III type vector array ; calculating an energy of each vector in said vector aggregate and an encoding gain; selecting a first M vectors with the biggest encoding gain to make the energy of the selected M vectors over 50% of a total energy.

11. The method of multi-resolution vector quantization for audio encoding of claim 9, wherein a numerical value of said M can be any integer from 3 to 50.

12. The method of multi-resolution vector quantization for audio encoding of claim 1, wherein the procedure of said quantizing the selected vectors further comprises: calculating an energy value of each area of the time-frequency plane or a absolute maximum; defining a global normalization factor; normalizing the selected vectors; calculating a local normalization factor of the vector and normalizing at second time; quantizing normalized vectors and calculating a residual error of quantization.

13. The method of multi-resolution vector quantization for audio encoding of claim 12, wherein the procedure of said quantizing the selected vectors further comprises: calculating the energy value of each area of the time-frequency plane or the absolute maximum ; forming a Unary Function Y=f(X), wherein X represents a serial number of an area, and Y represents the energy or the absolute maximum corresponding to area X; defining a global gain according to the total energy of the signal and quantizing and encoding it by a logarithm model; normalizing the selected vectors by the global gain; calculating the local normalization factor of a current vector according to Taylor Formula and normalizing the current vector once again; obtaining a general normalization factor of the current vector to be a product of the above two normalization factors; forming a M-dimensional vector by a function value of the selected M areas; calculating a first-order difference and a second-order difference corresponding to the vector; obtaining codebooks of the above three vectors by Codebook Training Algorithm and quantizing the above three vectors; quantization of the vectors corresponding to a zero-order approximate expression of Taylor Formula, and adopting an Euclidean distance for a distortion measure in codebook searching; quantization of the vector of the first-order difference corresponding to a first-order approximation of Taylor Formula, searching a few code words with the least distortion of the corresponding codebook according to the Euclidean distance, then calculating a quantization distortion of each area of a small neighborhood at the current vector x₀, at last summing up the distortion to be the distortion measure; quantization of the vector of the second-order difference being similar with the quantization of the vector of the first-order difference.

14. The method of multi-resolution vector quantization for audio encoding of claim 12, wherein the procedure of said quantizing the selected vectors further comprises: calculating the energy value of each area of the time-frequency plane or the absolute maximum ; forming a Unary Function Y=f(X), wherein X represents a serial number of an area, and Y represents the energy or the absolute maximum corresponding to area X; defining a global gain according to the total energy of the signal and quantizing and coding it by a logarithm model; normalizing the selected vectors by the global gain; calculating the local normalization factor of a current vector according to a Spline Curve Fitting Formula and normalizing the current vector once again; forming a M-dimensional vector by a function value of the selected M areas and the vector being able to be decomposed into several component vectors which are called vectors of selected points; quantizing the above vectors separately.

15. A method of multi-resolution vector quantization for audio decoding, characterized in that it comprises the following steps of: demultiplexing a code stream to gain a side information of the multi-resolution vector quantization, an energy of a selected point and location information of vector quantization; inverse quantizing vectors to obtain a normalized vector according to the above information and calculating a normalization factor to rebuild a quantized vector in an original time-frequency plane; adding the rebuilt vector to a residual error of a corresponding time-frequency coefficient according to the location information; obtaining a rebuilt audio signal by inverse filtering in multi-resolution and mapping from frequency to time.

16. The method of multi-resolution vector quantization for audio decoding of claim 15, wherein the step of said rebuilding a quantized vector in an original time-frequency plane further comprises: calculating an energy and values of each order difference of each selected point from a codebook according to the side information; obtaining the location information of vector quantization in the time-frequency plane and a global normalization factor from the code stream; obtaining a normalization factor at second time in the corresponding position in accordance with a formula used in encoding process to calculate a normalization factor at second time; obtaining the normalized vector according to a vector quantization index, multiplying the normalized vector with the above two normalization factors to rebuild a quantized vector in a time-frequency plane.

17. The method of multi-resolution vector quantization for audio decoding of claim 15, wherein the procedure of said inverse filtering in multi-resolution further comprises: organizing a time-frequency for the time-frequency coefficient of the rebuilt vector, performing following filtering according to types of signals obtained from decoding: if it is a graded signal, proceeding a cosine modulation filtering with equal bandwidth to gain a pulse code modulation output in a time domain; if it is a fast-varying signal, integrating in multi-resolution and proceeding a cosine modulation filtering with equal bandwidth to gain a pulse code modulation output in a time domain.

18. The method of multi-resolution vector quantization for audio decoding of claim 17, wherein the fast-varying signal can be further divided into various types of the fast-varying signal, integrating in multi-resolution and filtering are respectively performed to different types of the fast-varying signal.

19. A device of multi-resolution vector quantization for audio encoding, characterized in that it comprises: a time-frequency mapper, a multi-resolution filter, a multi-resolution vector quantizer, a psychological acoustic calculation module and a quantization encoder;
the time-frequency mapper for receiving an input audio signal to process mapping from time to frequency domain and output to the multi-resolution filter;
the multi-resolution filter foradaptively filtering the signal, and outputting a filtered signal to the psychological acoustic calculation module and the multi-resolution vector quantizer;
the multi-resolution vector quantizer for vector quantizing the filtered signal and calculating a residual error of quantization, transmitting a quantized signal as a side information to an audio decoder and outputting the residual error of quantization to the quantization encoder;
the psychological acoustic calculation module for calculating a masking threshold of a psychological acoustic model according to the input audio signal, and outputting the masking threshold to the quantization encoder so as to control noise allowed in quantization;
the quantization encoder for quantizing and entropy coding the residual error output by the multi-resolution vector quantizer to gain an encoded code stream information under restriction of the allowed noise output by the psychological acoustic calculation module.

20. The device of multi-resolution vector quantization for audio encoding of claim 19, wherein the multi-resolution filter comprises a transient measure calculation module, M equal bandwidth cosine modulation filters, N multi-resolution analyzing modules and time-frequency filter coefficient organization modules, and satisfying M=N+1;
the transient measure calculation module for calculating a transient measure of an input audio signal frame to determine a type of the signal frame;
the equal bandwidth cosine modulation filters for filtering the signal to gain a filter coefficient; if the signal is a graded signal, outputting the filter coefficient to the time-frequency filter coefficient organization module; if the signal is a fast-varying signal, transmitting the filter coefficient to the multi-resolution analyzing module;
the multi-resolution analyzing module for performing wavelet transform to the filter coefficient of the fast-varying signal, adjusting a time-frequency resolution of the coefficient, outputting a transformed coefficient to the time-frequency filter coefficient organization module;
the time-frequency filter coefficient organization module for organizing filtered output coefficients in a time-frequency plane and outputting the filtered signal.

21. The device of multi-resolution vector quantization for audio encoding of claim 19, wherein the multi-resolution vector quantizer comprises: a vector organization module, a vector selection module, a global normalization module, a local normalization module and a quantization module;
the vector organization module for organizing coefficients in the time-frequency plane output by the multi-resolution filter according to different dividing policies into a vector form, and outputting the vector to the vector selection module;
the vector selection module for selecting vectors to be quantized according to energy etc factors, and outputting the vectors to be quantized to the global normalized module;
the global normalized module for globally normalizing the vectors;
the local normalized for calculating a local normalization factor of each vector locally normalizing vectors output by the global normalized module and outputting to the quantization module;
the quantization module for quantizing vectors which are normalized at twice, and calculating the residual error of quantization.

22. A device of multi-resolution vector quantization for audio decoding, characterized in that it comprises: a decoding and inverse-quantizing device, a multi-resolution inverse-vector quantizer, a multi-resolution inverse filter and a frequency-time mapper;
the decoding and inverse -quantizing device for demultiplexing, entropy decoding and inverse-quantizing a code stream to obtain a side information and encoding data and outputting to the multi-resolution inverse-vector quantizer;
the multi-resolution inverse-vector quantizer for quantizing a inverse-vector to rebuild a quantized vector, adding a rebuilt vector to a residual coefficient of a time-frequency plane and outputting to the multi-resolution inverse filter;
the multi-resolution inverse filter for inverse filtering the vector rebuilt by the multi-resolution vector quantizer and outputting to the frequency-time mapper;
the frequency-time mapper for mapping a signal from frequency to time to obtain a final rebuilt audio signal.

23. The device of multi-resolution vector quantization for audio decoding of claim 22, wherein the multi-resolution inverse-vector quantizer comprises: a demultiplexing module, an inverse-quantizing module, a normalized vector calculation module, a vector rebuilding module and an addition module.
the demultiplexing module for demultiplexing a received code stream to obtain a normalization factor and a quantization index of a selected point;
the counter-quantized module for obtaining an energy envelope and location information of vector quantization according to the information output from the demultiplexing module, inverse-quantizing to obtain a vector of a guide point and a selected point, calculating a second normalization factor and outputting to the normalized vector calculation module;
the normalized vector calculation module for inverse-normalizing the vector of the selected point to obtain a normalized vector, and outputting to the vector rebuilding module;
the vector rebuilding module for inverse-normalizing the normalized vector once again according to the energy envelope to obtain the rebuilt vector;
the addition module for adding the rebuilt vector output from the vector rebuilding module to a residual error of inverse-quantization in the corresponding time-frequency plane to obtain an inverse-quantized time-frequency coefficient as an input of the multi-resolution inverse filter.

24. The device of multi-resolution vector quantization for audio decoding of claim 22, wherein the multi-resolution inverse filter further comprises: a time-frequency coefficient organization module, N multi-resolution integration modules and M equal bandwidth cosine modulation filters, satisfying M=N+1;
the time-frequency coefficient organization module for organizing inverse-quantized coefficients by filter input method, if a graded signal, inputting to the equal bandwidth cosine modulation filters ; if a fast-varying signal, outputting to the multi-resolution integration module;
the multi-resolution integration module for mapping a multi-resolution time-frequency coefficient to be a cosine modulation filter coefficient with equal bandwidth, and outputting to the equal bandwidth cosine modulation filters;
the equal bandwidth cosine modulation filters for filtering the signal to obtain a pulse coding modulation output in time domain.

25. The method of multi-resolution vector quantization for audio encoding of claim 10, wherein a numerical value of said M can be any integer from 3 to 50.
